(19) United States
(12) Patent Application Publication
(10) Pub. No.: US 2026/0359054 A1
(43) Pub. Date: Nov. 12, 2026

(54) ELECTRONIC SYSTEM FOR PERFORMING BRANCH PREDICTION AND OPERATING METHOD THEREOF

(71) Applicant: SAMSUNG ELECTRONICS CO., LTD., Suwon-si (KR)

(72) Inventors: Sungchan KANG, Suwon-si (KR); Jaechul PARK, Suwon-si (KR); Jungyeop OH, Suwon-si (KR); Changseung LEE, Suwon-si (KR)

(73) Assignee: SAMSUNG ELECTRONICS CO., LTD., Suwon-si (KR)

(21) Appl. No.: 19/575,306

(22) Filed: Mar. 23, 2026

(30) Foreign Application Priority Data
May 8, 2025 (KR) 10-2025-0059994

(51) Int. Cl. G06F 9/38; G06F 7/544; G06F 9/32

(52) U.S. Cl. CPC G06F 9/3844; G06F 7/5443; G06F 9/321

(57) ABSTRACT

An electronic system for performing branch prediction includes: at least one processor configured to perform tagged geometry (TAGE) branch prediction on a first instruction corresponding to a first program counter (PC); and a neural network device configured to perform neural network branch prediction on a second instruction corresponding to a second PC, wherein a miss prediction associated with the second PC is higher than a miss prediction associated with the first PC, wherein the neural network device includes an in-memory computing circuit, and wherein the in-memory computing circuit is configured to: receive first input data including the second PC and a global history register value, and perform at least one multiply-accumulate (MAC) operation on the first input data.

### CROSS-REFERENCE TO RELATED APPLICATION

This application is based on and claims priority under 35 U.S.C. § 119 to Korean Patent Application No. 10-2025-0059994, filed on May 8, 2025, in the Korean Intellectual Property Office, the disclosure of which is incorporated by reference herein in its entirety.

### BACKGROUND

### 1. Field

The disclosure relates to an electronic system performing branch prediction and an operating method thereof, and more particularly, to an electronic system performing branch prediction using an in-memory computing circuit and an operating method thereof.

### 2. Description of the Related Art

In general, a central processing unit (CPU) sequentially processes instructions of a program, and to this end, uses an instruction pipeline structure. However, branch instructions included in the program may change the flow of instructions to be executed next, which may lead to a problem with a pipeline interruption or execution of incorrect instructions until branch results are confirmed.

To prevent such a problem, the CPU may apply a branch prediction technology for predicting in advance whether a branch is taken or not taken (e.g., whether the execution proceeds according the branch, or does not proceed according to the branch) before branch instructions are actually executed. Based on prediction results, the CPU withdraws in advance instructions to be executed later and puts the instructions into a pipeline, thereby enabling continuous execution without stalling instruction processing.

Therefore, the higher the accuracy of the branch prediction, the less the pipeline waste, the overall instructions throughput and system performance may be improved, whereas when the prediction fails, the instructions already entered the pipeline need to be flushed, which may lead to performance degradation. Accordingly, a high-accuracy and low-resource branch prediction structure capable of efficiently performing prediction while maintaining high accuracy even under various branch conditions is required.

### SUMMARY

Provided is an electronic system performing branch prediction and an operating method thereof. The technical task to be achieved by the disclosure is not limited to the technical tasks as described above, and other technical tasks may be inferred from the following embodiments.

Additional aspects will be set forth in part in the description which follows and, in part, will be apparent from the description, or may be learned by practice of the presented embodiments of the disclosure.

In accordance with an aspect of the disclosure, an electronic system for performing branch prediction includes: at least one processor configured to perform tagged geometry (TAGE) branch prediction on a first instruction corresponding to a first program counter (PC); and a neural network device configured to perform neural network branch prediction on a second instruction corresponding to a second PC, wherein a miss prediction associated with the second PC is higher than a miss prediction associated with the first PC, wherein the neural network device includes an in-memory computing circuit, and wherein the in-memory computing circuit is configured to: receive first input data including the second PC and a global history register value, and perform at least one multiply-accumulate (MAC) operation on the first input data.

The at least one processor may be further configured to: receive second input data including the first PC and the global history register value, generate an index corresponding to a branch history table (BHT) based on the second input data, and predict a branch direction of a branch instruction corresponding to the first PC based on a BHT entry corresponding to the generated index.

The neural network device may be further configured to: predict a branch direction of a branch instruction corresponding to the second PC based on an operation result of the at least one MAC operation performed by the in-memory computing circuit, and generate output data including the predicted branch direction.

The first input data may further include a local history register value corresponding to the second PC.

The at least one processor may be further configured to: classify a type of a PC as one of a first type corresponding to the first PC or a second type corresponding to the second PC based on a miss prediction rate of a branch instruction associated with the PC, and based on the type of the PC being classified as the second type, transmit the PC to the neural network device.

The in-memory computing circuit may be further configured to: perform a plurality of MAC operations using a plurality of crossbar arrays.

The plurality of crossbar arrays may be sequentially connected to each other according to operation steps.

The in-memory computing circuit may include a first crossbar array configured to store first weight data, and a second crossbar array configured to store second weight data different from the first weight data.

The in-memory computing circuit may be further configured to: perform a first MAC operation on the first input data using the first crossbar array to obtain an operation result, and perform a second MAC operation on the operation result using the second crossbar array.

In accordance with an aspect of the disclosure, an electronic device for performing branch prediction includes: at least one processor configured to perform tagged geometry (TAGE) branch prediction on a first instruction corresponding to a first program counter (PC); and a neural network device configured to perform neural network branch prediction on a second instruction corresponding to a second PC, wherein a miss prediction associated with the second PC is higher than a miss prediction associated with the first PC, wherein the neural network device includes an in-memory computing circuit, and wherein the in-memory computing circuit is configured to: receive input data including the second PC and a global history register value, and perform at least one multiply-accumulate (MAC) operation on the input data.

In accordance with an aspect of the disclosure, an operating method of an electronic system for performing branch prediction includes: performing, by at least one processor, tagged geometry (TAGE) branch prediction on a first instruction corresponding to a first program counter (PC); performing, by a neural network device, neural network branch prediction on a second instruction corresponding to a second PC, wherein a miss prediction associated with the second PC is higher than a miss prediction associated with the first PC; receiving, by an in-memory computing circuit included in the neural network device, first input data including the second PC and a global history register value; and performing, by the in-memory computing circuit, at least one multiply-accumulate (MAC) operation on the first input data.

The performing of the TAGE branch prediction may include: receiving second input data including the first PC and the global history register value; generating an index corresponding to a branch history table (BHT) based on the second input data; and predicting a branch direction of a branch instruction corresponding to the first PC based on a BHT entry corresponding to the generated index.

The performing of the neural network branch prediction may include: predicting a branch direction of a branch instruction corresponding to the second PC based on a MAC operation result of the at least one MAC operation performed by the in-memory computing circuit; and generating output data including the predicted branch direction.

The first input data further may include a local history register value corresponding to the second PC.

The operating method may further include: classifying, by the processor, a type of a PC as one of a first type corresponding to the first PC or a second type corresponding to the second PC based on a miss prediction rate of a branch instruction associated with the PC; and based on the type of the PC being classified as the second type, transmitting, by the processor, the PC to the neural network device.

The operating method may further include: performing, using the in-memory computing circuit, a plurality of MAC operations using a plurality of crossbar arrays.

The plurality of crossbar arrays may be sequentially connected to each other according to operation steps.

Each crossbar array from among the plurality of crossbar arrays may include a plurality of row lines, a plurality of column lines intersecting the plurality of row lines, and a plurality of nonvolatile memory cells disposed at intersections of the plurality of row lines and the plurality of column lines.

The in-memory computing circuit may include a first crossbar array configured to store first weight data and a second crossbar array configured to store second weight data different from the first weight data.

The operating method may further include: performing, using the in-memory computing circuit, a first MAC operation on the first input data using the first crossbar array to obtain an operation result, and performing, using the in-memory computing circuit, a second MAC operation on the operation result using the second crossbar array.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for explaining an overall outline of a branch prediction technology according to an embodiment;

FIG. 2 is a diagram illustrating an architecture of a neural network according to an embodiment;

FIG. 3 is a diagram illustrating operations being performed in a neural network according to an embodiment;

FIG. 4 is a diagram illustrating an in-memory computing circuit according to an embodiment;

FIG. 5 is a diagram illustrating an electronic system performing branch prediction according to an embodiment;

FIG. 6 is a diagram for specifically explaining data input to each component of the electronic system of FIG. 5 according to an embodiment;

FIG. 7 is a diagram for explaining a neural network structure implemented in a neural network device of FIG. 6 according to an embodiment;

FIG. 8 is a diagram for explaining an operation process performed in an in-memory computing circuit of FIG. 6 according to an embodiment; and

FIG. 9 is a flowchart for explaining an operating method of an electronic system performing branch prediction according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expressions “at least one of A, B, and C” and “at least one of A, B, or C” may be understood as including only A, only B, only C, both A and B, both A and C, both B and C, or all of A, B, and C.

The terms used to describe the present embodiments may include currently widely used general terms possible in consideration of their functions in the present embodiments, but this may vary depending on the intention or precedent of a technician in the art, the emergence of a new technology, and the like. In addition, in certain cases, there may be arbitrarily selected terms, and in this case, the meaning is described in detail in the description of the embodiment. Therefore, the terms used in the present embodiments should not be defined simply as the names of the terms, and instead should be defined based on the meanings of the terms and the overall content of the present embodiments.

In the descriptions of embodiments, when a first part is described as being connected to a second part, this may mean that the first part is directly connected to the second part, and may also mean that the first part is indirectly connected or electrically connected with another component therebetween. Singular expressions include plural expressions unless the context clearly means otherwise. In addition, when a part “contains” a component, this may mean that the part may contain other components, rather than excluding other components, unless otherwise stated.

Terms such as “consists of”, “includes”, or the like used in the present embodiments should not be construed as necessarily including all of the various components or steps described herein, and it should be construed such that some of the components or some steps may not be included, or additional components or steps may be included.

In addition, terms including ordinal numbers, such as “first” or “second” used in this specification, may be used to describe various components, but the components should not be limited by the terms. The terms may be used only for the purpose of distinguishing one component from another.

The following description of particular examples of embodiments should not be construed as limiting the scope of rights, and what those skilled in the art may easily infer should be construed as belonging to the scope of rights of embodiments of the present disclosure. Hereinafter, embodiments solely for illustration are described in detail with reference to the accompanying drawings.

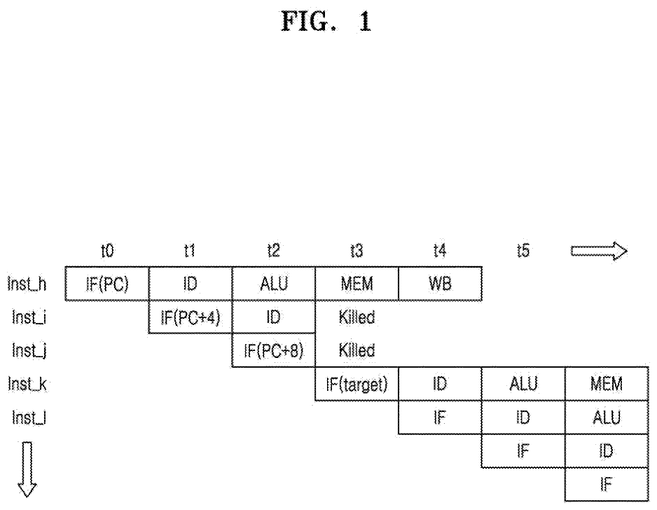

FIG. 1 is a diagram for explaining an overall outline of a branch prediction technology.

A central processing unit (CPU) may continuously process instructions included in a program (e.g., a computer program) using an instruction pipeline. However, branch instructions may be often included in the program, and may dynamically change the flow of instructions to be performed next.

The CPU may not accurately retrieve the next instructions until actual branch results of the branch instructions are confirmed, which may cause a pipeline interruption or a prior execution of incorrect instructions. To solve this problem, the CPU may apply a branch prediction technology (e.g., may perform branch prediction) for predicting in advance whether the branch instructions are taken or not taken.

The branch prediction may determine a branch direction of the branch instructions in advance, and may retrieve in advance and execute next instructions according to prediction results, thereby preventing the interruption of instruction pipeline and improving the overall processing efficiency In particular, the higher the prediction accuracy, the lower the pipeline stall, and thus the instruction throughput of the CPU may be stably maintained. However, when the prediction is incorrect, the instructions already executed in the pipeline may be flushed, and thus the overall execution speed of the system may be slowed.

Referring to FIG. 1, in an instruction pipeline structure, each instruction may be processed sequentially through operations corresponding to at least one of an instruction fetch operation IF, an instruction decoding operation ID, an operation execution operation ALU, a memory access operation MEM, and a result writing operation WB according to axes of times t0 to t5. An instruction Inst_h may be a branch instruction, and when it is confirmed that a branch result of the branch instruction is taken at the time t3, the flow of the instruction may be changed to an instruction Inst_target located at a branch target address. According to embodiments, a branch result being taken may mean that execution of the program may proceed by executing instructions included in a branch corresponding to the branch result, and the branch result being not taken may mean that the execution of the program may proceed without executing the instructions included in the branch corresponding to the branch result.

However, at the time t1 and the time t2 before the branch result is confirmed, the CPU may assume that the branch result is not taken, and may start execution by fetching an instruction Inst_i and an instruction Inst_j into a pipeline. Thereafter, when it is confirmed that the branch result is taken, the instruction Inst_i and the instruction Inst_j may be determined as instructions fetched according to an incorrect branch prediction, and may be killed or flushed from the pipeline. This instruction flush phenomenon may cause waste of instruction processing, and may therefore negatively affect the processing speed of the entire system.

However, when the accuracy of the branch prediction is high, the occurrence of a pipeline interruption may be reduced, and thus the CPU may process instructions more continuously and efficiently. Therefore, a high-accuracy branch prediction technology may be used to maintain the efficiency of the pipeline and prevent performance degradation of the entire system.

One example of a branch prediction technology may be referred to as a tagged geometric (TAGE) prediction process. The TAGE prediction method may generate an index by combining a program counter (PC) and a global history storing execution results of recent branches, and then access one of a plurality of pattern history tables based on the index. In this regard, the tables may be configured using history information of different lengths and designed to correspond to various branch patterns. For example, each of the tables may further include a tag, a counter, a usefulness bit, etc., in addition to direction information of branch instructions.

Therefore, a TAGE predictor (e.g., one or more components or elements that may implement or perform a TAGE prediction process or otherwise generate a TAGE prediction) may effectively process a branch that is predictable with only a short history, and also a branch with long history dependence. However, when noise is mixed in the global history, (e.g., when results of unrelated branches are included in the history), a problem of deteriorating prediction accuracy may occur.

To improve this problem, a neural network may be used, and a perceptron-based dynamic branch prediction process may be performed as one of the branch prediction techniques.

According to embodiments, a perceptron-based dynamic branch prediction process may include selecting a perceptron corresponding to a branch instruction from a table of perceptrons according to a branch address, and predicting a branch direction according to results accumulated by multiplying a weight of the perceptron by a branch history value. In this regard, the branch history value may refer to a vector of values obtained by converting execution results of recent branches into a binary value (e.g., a value of positive one (“+1”) or negative one (“−1”)), and the branch direction may be determined to be taken or not taken according to whether the sum is greater than or equal to a value of zero (“0”) after multiplying the weight of the perceptron by the branch history value.

The perceptron-based prediction method may learn a more complex branch pattern than the TAGE prediction method, which may improve prediction accuracy. However, because a neural network structure used in such prediction method may be a single-layer structure, there may be a problem that a nonlinear relationship between the branch history and the branch result may not be sufficiently reflected.

According to some approaches, a branch prediction process may be performed using a convolutional neural network (CNN). This process may include training a model using large-scale branch history data offline, and then predicting the branch direction using a trained model. In this regard, the branch history data may further include the branch address (e.g., the PC) and a past execution result of a particular branch instruction (e.g., a local history) in addition to the execution results of recent branches (e.g., global history).

This CNN-based branch prediction method may provide relatively high-precision branch prediction performance, but there may be a problem that consumption of hardware resources such as computational units, memory resources, and power consumption may be relatively high due to a plurality of convolution layers and weight operation processing.

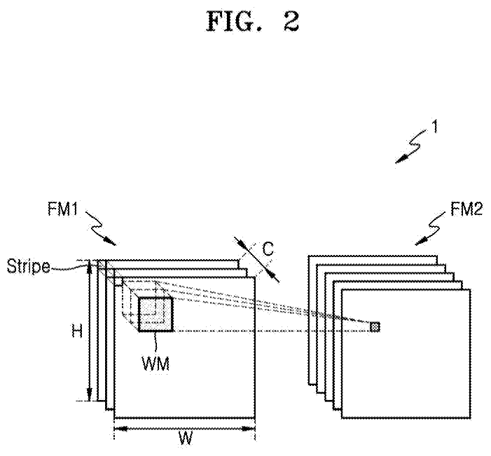

According to embodiments, by predicting the branch direction using an in-memory computing circuit, a new process for branch prediction technology may be provided that is capable of improving prediction accuracy and reducing computational cost and power consumption while improving the above-described problems. Before explaining examples of the branch prediction technology using the in-memory computing circuit, examples of the neural network and the in-memory computing circuit are briefly described with reference to FIGS. 2 to 4.

FIG. 2 is a diagram illustrating an architecture of a neural network 1 according to an embodiment.

Referring to FIG. 2, the neural network 1 may be expressed as a mathematical model using nodes and edges. The neural network 1 may be, or may include, an architecture of a deep neural network (DNN) or an n-layers neural network. The DNN or the n-layers neural network may correspond to a convolutional neural network (CNN), a recurrent neural network (RNN), a deep belief network (DBN), a restricted Boltzmann machine (RBM), etc. For example, the neural network 1 may be implemented as the CNN, but embodiments are not limited thereto. The neural network 1 of FIG. 2 may correspond to some layers of the CNN. Therefore, the neural network 1 may correspond to a convolution layer, a pooling layer, a fully connected layer, etc. of the CNN.

In the convolution layer, a first feature map FM1 may correspond to an input feature map, and a second feature map FM2 may correspond to an output feature map. A feature map may refer to a data set in which various features of input data are expressed. The first and second feature maps FM1 and FM2 may be high-dimensional matrices of two or more dimensions, and each may have its own activation parameters. When the first and second feature maps FM1 and FM2 correspond to, for example, 3-dimensional feature maps, the first and second feature maps FM1 and FM2 may have a width W (which may be referred to as a column), a height H (which may be referred to as a row), and a depth C. At this time, the depth C may correspond to the number of channels.

The first feature map FM1 may include a plurality of input stripes. For example, the first feature map FM1 may include H×W input stripes. An input stripe may refer to channel-wise input data for one space of an input feature map, and may have a size of 1×1×C. For example, the input stripe may include C input activations.

In the convolution layer, convolution operation may be performed on the first feature map FM1 and a weight map WM, and as a result, the second feature map FM2 may be generated. The weight map WM may filter the first feature map FM1 and may be referred to as a weight filter or a weight kernel. As an example, a depth of the weight map WM (e.g., the number of channels), may be equal to the depth C of the first feature map FM1 (e.g., the number of channels). The weight map WM may be shifted by traversing the first feature map FM1 using a sliding window. During each shift, each of the weights included in the weight map WM may be multiplied with and added to all feature values in an area overlapping the first feature map FM1. As the weight map WM is convolved with the first feature map FM1, one channel of the second feature map FM2 may be generated.

Although FIG. 2 illustrates an example including one weight map WM, embodiments are not limited thereto. For example, in some embodiments, a plurality of weight maps may be convolved with the first feature map FM1 to generate a plurality of channels in the second feature map FM2. According to embodiments, the second feature map FM2 of the convolution layer may be an input feature map of a next layer. For example, the second feature map FM2 may be an input feature map of the pooling layer. However, the second feature map FM2 is not limited thereto.

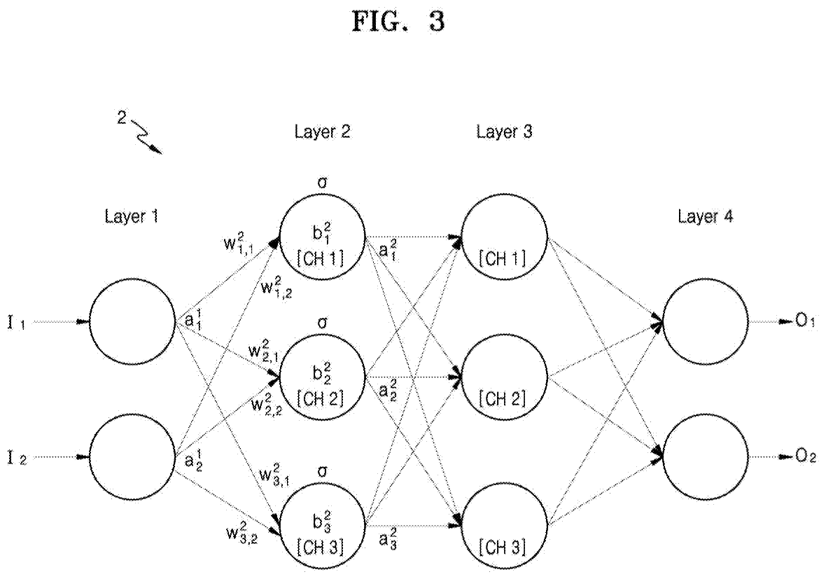

FIG. 3 is a diagram illustrating operations being performed in a neural network 2 according to an embodiment.

Referring to FIG. 3, the neural network 2 may have a structure including an input layer, hidden layers, and an output layer, and may perform operations based on received input data (e.g., I₁ and I₂) and generate output data (e.g., O₁ and O₂) based on results of the operations.

The neural network 2 may include the DNN including two or more hidden layers, or the n-layers neural network, as described above. For example, as illustrated in FIG. 3, the neural network 2 may be the DNN including an input layer (illustrated as “Layer 1”), two hidden layers (illustrated as “Layer 2 and Layer 3”), and an output layer (illustrated as “Layer 4”). When the neural network 2 is implemented with an architecture of the DNN, because the neural network 2 may include more layers that may process valid information, the neural network 2 may process more complex data sets than a neural network with a single layer. According to embodiments, the neural network 2 is illustrated as including four layers in FIG. 3, but this is only an example, and the neural network 2 may include fewer or more layers or fewer or more channels. In addition, the neural network 2 may include layers of various structures different from those illustrated in FIG. 3.

Each of the layers included in the neural network 2 may include a plurality of channels. The channel may correspond to a plurality of artificial nodes, which may be referred to as neurons, processing elements (PE), units, or other similar terms. For example, as illustrated in FIG. 3, Layer 1 may include two channels (or nodes), and Layer 2 and Layer 3 may each include three channels. However, this is only an example and each layer included in the neural network 2 may include a different number of channels (or nodes).

The channels included in each layer of the neural network 2 may be connected to each other to process data. For example, one channel may receive data from other channels, perform operations based on received data, and output the results of the operations to still other channels.

An input and an output of each of the channels may be referred to as input activation and output activation, respectively. For example, an activation may be a parameter corresponding to both the output of one channel and the input of the channels included in the next layer. According to embodiments, each of the channels may determine its own activation based on activations and weights received from the channels included in the previous layer. A weight may be a parameter used to calculate the output activation in each channel and may be a value assigned to connection relationship between channels.

Each of the channels may be processed by a computational unit or a processing element that receives the input and outputs output activations, and the input and output of each of the channels may be mapped to each other. For example, σ may denote an activation function,

$${w}_{jk}^{i}$$

may denote a weight from a k-th channel included in an (i−1)-th layer to a j-th channel included in an i-th layer,

$${b}_{j}^{i}$$

may denote a bias of the j-th channel included in the i-th layer, and

$${a}_{j}^{i}$$

may denote an activation of the j-th channel of the i-th layer, and the activation

$${a}_{j}^{i}$$

may be calculated using the following Equation 1.

$${a}_{j}^{i} = σ ( {\sum }_{k} ( {w}_{jk}^{i} \times {a}_{k}^{i - 1} ) + {b}_{j}^{i} ) \qquad [ Equation 1 ]$$

As illustrated in FIG. 2, the activation of a first channel CH 1 of the second Layer 2 may be expressed as

$${a}_{1}^{2} .$$

### Additionally,

$${a}_{1}^{2}$$

may have a value of

$${a}_{1}^{2} = σ ( {w}_{1 , 1}^{2} \times {a}_{1}^{1} + {w}_{1 , 2}^{2} \times {a}_{2}^{1} + {b}_{1}^{2} )$$

according to Equation 1. The activation function σ may include a rectified linear unit (ReLU), but embodiments are not limited thereto. For example, in some embodiments, the activation function σ may include a sigmoid function, a hyperbolic tangent (tan h) function, a maxout function, etc.

As described above, in the neural network 2, numerous data sets may be exchanged between multiple interconnected channels, and undergo computational processes as the data sets pass through layers. In this type of computational process, numerous multiply-accumulate (MAC) operations may be performed, and numerous memory access operations may be performed together to load the activation and weight, which are operands of the MAC operation, at an appropriate time.

According to some approaches, digital computers in which a computational unit and memory are separated may utilize a von Neumann architecture, which may include a common data bus for data transmission between two separated blocks. Therefore, in a process of implementing the neural network 2 in which data movements and calculations are continuously repeated, a large amount of time may be used to perform data transmission and excessive power may be consumed. To address these issues, an in-memory computing circuit may be used as an architecture that integrates the computational unit and memory, in order to perform the MAC operation.

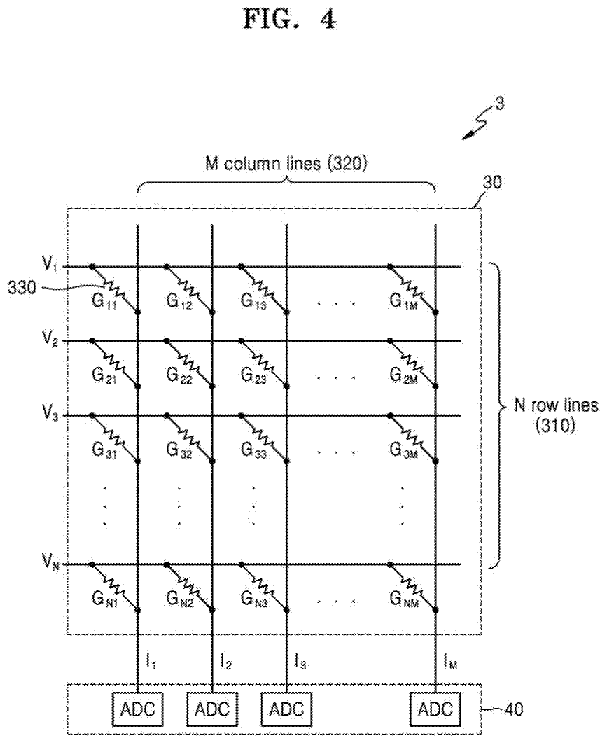

FIG. 4 is a diagram illustrating an in-memory computing circuit 3 according to an embodiment.

Referring to FIG. 4, the in-memory computing circuit 3 may include an analog crossbar array 30 and an analog-to-digital converter (ADC) 40. However, the in-memory computing circuit 3 illustrated in FIG. 4 is only an example, and embodiments are not limited thereto. Therefore, one of ordinary skill in the art should understand that the in-memory computing circuit 3 may include other components in addition to, or instead of, the components illustrated in FIG. 4.

The analog crossbar array 30 may include a plurality of row lines 310, a plurality of column lines 320, and a plurality of memory cells 330. The plurality of row lines 310 may be used to receive input data. For example, when the plurality of row lines 310 are N row lines (wherein N is a natural number), voltages V₁, V₂, . . . , and V_{N} corresponding to input activations may be applied to the N row lines, respectively. The plurality of column lines 320 may intersect the plurality of row lines 310. For example, when the plurality of column lines 320 are M column lines (wherein M is any natural number), the plurality of column lines 320 and the plurality of row lines 310 may intersect at N×M intersection points.

According to embodiments, the plurality of memory cells 330 may be arranged at the intersection points of the plurality of row lines 310 and the plurality of column lines 320. Each of the plurality of memory cells 330 may be implemented as a non-volatile memory, such as resistive random access memory (ReRAM), embedded flash (eFlash), etc., to store weights, but is not necessarily limited thereto. Each of the plurality of memory cells 330 may include a volatile memory, such as static random access memory (SRAM).

In the example illustrated in FIG. 4, the plurality of memory cells 330 may have conductances G₁₁, . . . , and G_{NM} corresponding to weights, and when a voltage corresponding to input activation is applied to each of the plurality of row lines 310, a current having a size of I=V×G may be output through each of the plurality of memory cells 330 according to Ohm's law. The currents output from the plurality of memory cells 330 arranged along each column line may be combined with each other, so current sums I₁, . . . , and I_{M} may be output along the plurality of column lines 320, respectively. The current sums I₁, . . . , and I_{M} may correspond to the results of the MAC operations performed in an analog manner.

The ADC 40 may convert the results of analog MAC operations (e.g., current sums I₁, . . . , I_{M}), output from the analog crossbar array 30, into digital signals. The results of the MAC operations, converted into the digital signals, may be output from the ADC 40 and then may be used in a subsequent neural network operation process.

Although FIG. 4 illustrates an example including an analog crossbar array, embodiments are note limited thereto. For example, in some embodiments, a digital cross array may be implemented according to the design goal and application fields of the crossbar array. In this case, in the in-memory computing circuit 3, the ADC 40 converting the operation result of the crossbar array into a digital signal may be omitted.

Hereinafter, an example of a method, performed by an electronic system according to the disclosure, for predicting a branch direction of a branch instruction using an in-memory computing circuit will be described.

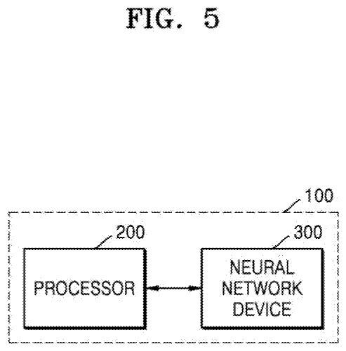

FIG. 5 is a diagram illustrating an electronic system 100 for performing branch prediction according to an embodiment.

Referring to FIG. 5, the electronic system 100 according to an embodiment may include a processor 200 and a neural network device 300. However, the electronic system 100 of FIG. 5 is only an example, and embodiments are not limited thereto. For example, one of ordinary skill in the art should understand that other general-purpose components may be further included in addition to, or instead of, those illustrated in FIG. 5.

The processor 200 may perform an overall function of controlling the electronic system 100. For example, the processor 200 may control the operation of the neural network device 300. According to embodiments, the processor 200 may be implemented as an array of multiple logical gates, or may be implemented as a combination of a general-purpose microprocessor and memory storing a program executable in the microprocessor.

The processor 200 may perform branch prediction on some instructions in the program. For example, the processor 200 may perform branch prediction on instructions associated with a relatively easy-to-predict PC using a TAGE prediction method. However, the neural network device 300 may perform branch prediction on remaining instructions in the program. For example, the neural network device 300 may perform branch prediction using a prediction method using a CNN on instructions associated with corresponding to a relatively hard-to-predict PC.

Whether an instruction targeted for branch prediction is associated with the relatively easy-to-predict PC or the relatively hard-to-predict PC may not be predetermined, and instead may be determined in any manner, for example using experimentation. For example, by performing prediction on all branch instructions in the program using a TAGE predictor and writing the execution of the program using a program instrumentation tool such as PinPlay, prediction result data with respect to each PC and the corresponding branch direction may be collected. Thereafter, branch instructions may be sorted according to a miss prediction rate, and then a PC corresponding to an instruction associated with a relatively high miss prediction rate (e.g., a miss prediction rate that is greater than or equal to a threshold miss prediction rate) may be determined to be (or classified as) the relatively hard-to-predict PC, and a PC corresponding to an instruction associated with a relatively low miss prediction rate (e.g., a miss prediction rate that is less than the threshold miss prediction rate) may be determined to be (or classified as) the relatively easy-to-predict PC.

According to the relative ease of prediction classified as described above, the electronic system 100 according to an embodiment may perform branch prediction in a TAGE prediction process on the instruction associated with the relatively low miss prediction rate through the processor 200, and may perform branch prediction by applying a CNN-based prediction process on the instruction associated with the high miss prediction rate using the neural network device 300.

As another example, the processor 200 may classify types of PCs included in the branch instruction, and may then determine a process for performing branch prediction on the branch instruction based on the types of PCs.

The processor 200 may classify the types of PCs included in the branch instruction based on the miss prediction rate of the PC. For example, the types of PCs may include a first type corresponding to the easy-to-predict PC and a second type corresponding to the relatively hard-to-predict PC. In this regard, the relatively hard-to-predict PC may mean a PC corresponding to the instruction associated with the relatively high miss prediction rate, and the relatively easy-to-predict PC may mean a PC corresponding to the instruction associated with the relatively low miss prediction rate.

Based on the type of PC being classified as the first type (e.g., corresponding to the relatively easy-to-predict PC), a branch direction of the instruction corresponding to the PC may be predicted by the processor 200 according to the TAGE prediction process. However, based on the type of PC being classified as the first type (e.g., corresponding to the relatively hard-to-predict PC), the instruction corresponding to the PC may be transmitted to the neural network device 300, and then a branch direction thereof may be predicted by the neural network device 300 according to a CNN-based prediction process. For example, the electronic system 100 of the disclosure may apply the TAGE prediction process associated with relatively low operation cost and relatively low resource consumption to a relatively easy-to-predict instruction, and may apply the CNN-based prediction process associated with a relatively high prediction accuracy to a relatively hard-to-predict instruction, thereby improving the overall accuracy of branch prediction and utilizing hardware resources more efficiently.

Although FIG. 5 illustrates an example which includes only one processor 200, embodiments are not limited thereto. According to an embodiment, the processor 200 for performing branch prediction may be implemented in a configuration independent of a processor performing an overall function of controlling the electronic system 100.

In some embodiments, the electronic system 100 of the disclosure may be applied to an electronic device for performing branch prediction. For example, the electronic system 100 may be applied to an electronic device such as an artificial intelligence (AI) operation accelerator, an autonomous vehicle, a drone, etc., and may be mounted on at least one of various types of electronic devices.

The electronic device may include a processor for the electronic device, RAM, memory, and the neural network device 300. The electronic device may further include memory, a sensor module, a communication module, an input/output module, a security module, a power control device, etc. Some hardware components of the electronic device may be mounted on at least one chip.

The processor for the electronic device controls the overall operation of the electronic device. The processor for the electronic device may include a single processor core or multi-processor cores. The processor for the electronic device may process or execute programs and/or data stored in the memory. In some embodiments, the processor for the electronic device may control the function of the neural network device 300 by executing the programs stored in the memory. The processor for the electronic device may be implemented as a CPU, a graphics processing unit (GPU), an application processor (AP), etc.

The processor for the electronic device may include the processor 200 described with reference to FIG. 5. For example, the processor for the electronic device may perform all functions performed by the processor 200. For example, the processor for the electronic device may perform branch prediction on instructions associated with the relatively easy-to-predict PC using the TAGE prediction method. Based on the prediction result data arbitrarily determined experimentally, the processor for the electronic device may perform branch prediction on the instruction associated with the relatively low miss prediction rate using the TAGE prediction method. In addition, the processor for the electronic device may control the neural network device 300 to perform branch prediction on instructions associated with the relatively hard-to-predict PC.

As an example, the processor for the electronic device may classify the types of PCs included in the branch instruction, and then determine a method of performing branch predictions on the branch instruction based on the types of PCs. When the type of PC is classified as the first type corresponding to the relatively easy-to-predict PC, the processor for the electronic device may perform branch prediction on the instruction corresponding to the PC in the TAGE prediction method. However, when the type of PC is classified as the second type corresponding to the relatively hard-to-predict PC, the processor for the electronic device may transmit the instruction corresponding to the PC to the neural network device 300. In this regard, the processor for the electronic device may control the neural network device 300 to perform branch prediction on the received instructions.

The RAM may temporarily store programs, data, or instructions. For example, the programs and/or data stored in the memory may be temporarily stored in the RAM according to the control or booting code of the processor for the electronic device. The RAM may be implemented as memory such as dynamic RAM (DRAM) or SRAM.

The memory, which is a storage storing data, may store an operating system (OS), various programs, and various data. In an embodiment, the memory may store intermediate results generated during an operation performing process of the neural network device 300.

The memory may be the DRAM, but embodiments are not limited thereto. The memory may include at least one of a volatile memory or a nonvolatile memory. The nonvolatile memory includes Read Only Memory (ROM), Programmable ROM (PROM), Electrically Programmable ROM (EPROM), Electrically Erasable and Programmable ROM (EEPROM), flash memory, Phase-change RAM (PRAM), Magnetic RAM (MRAM), RRAM, Ferroelectric RAM (FeRAM), etc. The volatile memory includes DRAM, SRAM, Synchronous DRAM (SDRAM), PRAM, MRAM, Resistive RAM (RRAM), FeRAM, etc. In an embodiment, the memory may include at least one of a hard disk drive (HDD), a solid state drive (SSD), a compact flash (CF), a secure digital (SD), a micro-secure digital (micro-SD), a mini-secure digital (mini-SD), or a memory stick.

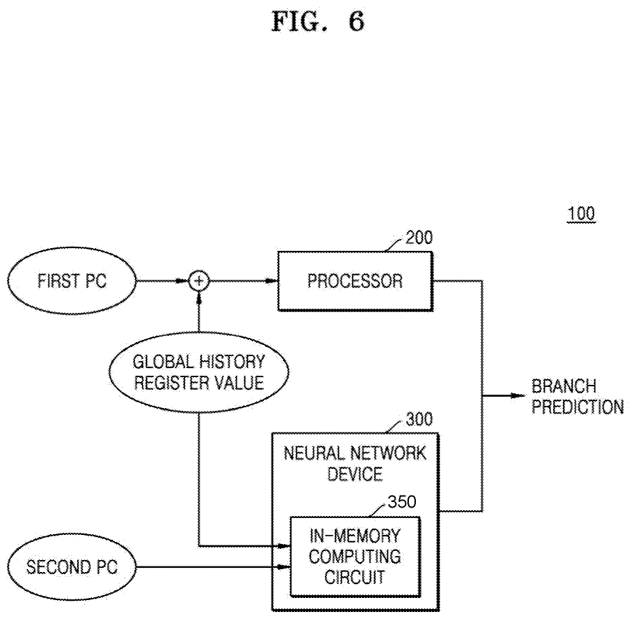

FIG. 6 is a diagram for specifically explaining data input to each component of the electronic system 100 of FIG. 5

Referring to FIG. 6, the processor 200 may perform branch prediction by receiving a first PC and a global history register value as input data, and the neural network device 300 may perform branch prediction by receiving a second PC and a global history register value as input data.

According to embodiments, the first PC may be a PC indicated as having a relatively low miss prediction, and the second PC may be a PC indicated as having a relatively high miss prediction. For example, according to a TAGE prediction process, a miss prediction rate associated with the first PC may be lower than a miss prediction rate associated with the second PC, and information about the miss prediction rate may be displayed or otherwise provided or indicated with respect to each PC.

For example, the first PC may include metadata indicating that the miss prediction rate of the corresponding instruction predicted by a TAGE predictor is relatively low, and the second PC may include metadata indicating that the miss prediction rate of the corresponding instruction predicted by the TAGE predictor is relatively high.

The global history register may include history information indicating branch results of recently executed branch instructions. For example, the global history register may include information sequentially storing results of branch directions (e.g., whether a corresponding branch is taken or not taken) of branch instructions up to a present time or a predetermined past time.

The processor 200 may receive the first PC and the global history register value as input data. In this regard, the global history register value may mean a value stored in the global history register, or may be referred to as an entry value of a global history table.

The processor 200 may generate an index to be used in a branch history table (BHT) by referring to the received first PC and the global history register value. The processor 200 may predict a branch direction corresponding to a branch instruction corresponding to the first PC based on a BHT entry corresponding to the generated index.

In this regard, the BHT may include history information about branch directions of all branch instructions, and the BHT entry may mean one slot (or cell) corresponding to a particular branch instruction in a table. For example, the processor 200 may predict a branch direction of an instruction including the first PC based on the first PC and the global history register value.

The neural network device 300 may predict a branch direction of a branch instruction corresponding to the second PC by receiving the second PC and the global history register value as input data and performing at least one MAC operation on the received input data. For example, the neural network device 300 may predict the branch direction of the instruction including the second PC through a CNN-based prediction method.

The neural network device 300 may include an in-memory computing circuit 350. The in-memory computing circuit 350 may perform at least one MAC operation on the input data. The neural network device 300 may generate the branch direction of the branch instruction corresponding to the second PC as output data based on an operation result of the in-memory computing circuit 350.

In some embodiments, the input data received by the processor 200 or the neural network device 300 may further include a local history register value. In this regard, the local history register value may mean a value stored in the local history register, or be referred to as an entry value of a local history table. The local history register may include history information indicating a branch result of a particular branch instruction. For example, the local history register may include information sequentially storing results of branch directions (taken or not taken) of branch instructions including a particular PC.

In particular, in the case of a relatively hard-to-predict PC, such as the second PC, the neural network device 300 may further receive the local history register value as input data in addition to the second PC and the global history register value, thereby improving the accuracy of branch prediction.

The electronic system 100 according to the disclosure may perform TAGE branch prediction on the first PC, which is a relatively easy-to-predict PC, and perform CNN-based branch prediction on the second PC, which is a relatively hard-to-predict PC, using the neural network device 300 including the in-memory computing circuit 350. Accordingly, the electronic system 100 of the disclosure may directly perform branch prediction on the relatively hard-to-predict PC in the memory, thereby improving energy efficiency by minimizing delay and power consumption due to a data movement while improving the overall accuracy of branch prediction.

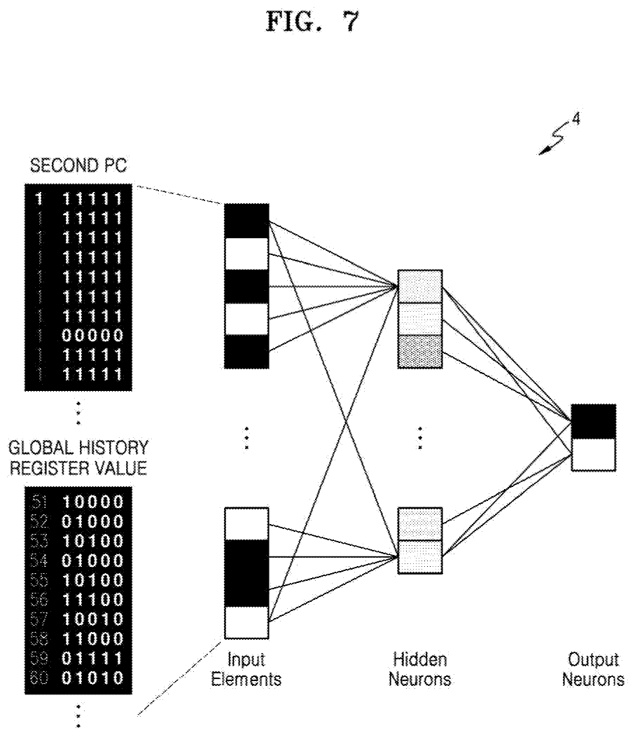

FIG. 7 is a diagram for explaining a neural network structure implemented in the neural network device 300 of FIG. 6.

Referring to FIG. 7, the neural network device 300 may include a multi-layer perceptron (MLP) structure 4. The MLP structure 4 may include an input layer, at least one hidden layer, and an output layer, and neurons of each hidden layer and output layer may be fully connected to all neurons of a previous layer.

The input layer may receive input elements and transmit the input elements to the hidden layer. The hidden layer may include one or more hidden neurons, and perform an operation based on input data transmitted from the input layer. The output layer may receive an operation result of the hidden layer as an input and generate output data through one or more output neurons.

The neural network device 300 may learn a nonlinear relationship between a global history register value and a branch direction of a branch instruction corresponding to the second PC using the MLP structure 4. The neural network device 300 may receive the second PC and the global history register value as input data and generate a result of predicting the branch direction of the branch instruction corresponding to the second PC as output data.

For example, the neural network device 300 may include an input layer configured to receive about 400 bits of input elements, a hidden layer including about 100 bits of hidden neurons, and an output layer including about 2 bits of output neurons. In this regard, the input elements of about 400 bits may include a second PC of about 50 bits and a global history register value of about 350 bits, and a value of the output neuron expressed in about 2 bits may represent the branch direction of the instruction including the second PC and the reliability of the corresponding prediction.

Each layer included in the MLP structure 4 of the neural network device 300 may be implemented by a plurality of crossbar arrays each configured to perform the MAC operation. The neural network apparatus 300 may perform a plurality of MAC operations using the plurality of crossbar arrays. For example, the plurality of crossbar arrays may be sequentially connected to perform the plurality of MAC operations corresponding to the respective layers of the MLP structure 4. The neural network device 300 may include a structure in which the plurality of crossbar arrays are hierarchically disposed, thereby performing a hierarchical operation based on the MLP structure 4.

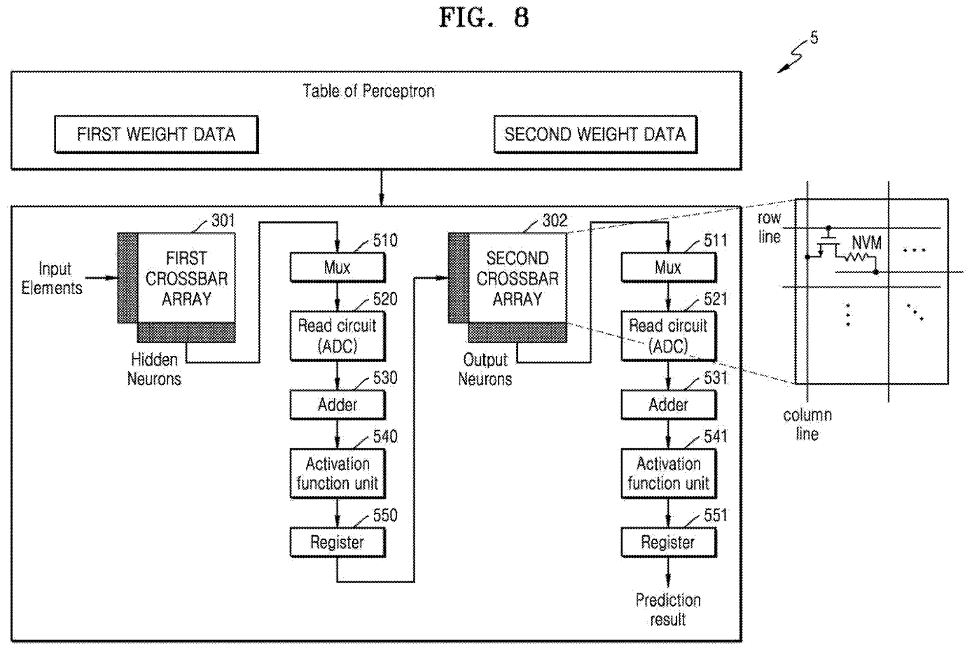

FIG. 8 is a diagram for explaining an operation process performed in the in-memory computing circuit 350 of FIG. 6.

Referring to FIG. 8, the in-memory computing circuit 350 may include a first crossbar array 301 and a second crossbar array 302, and the first crossbar array 301 and the second crossbar array 302 may be sequentially connected to each other according to operation steps. For example, output data of the first crossbar array 301 may be input to the second crossbar array 302 as input data.

First weight data may be stored in the first crossbar array 301. The first crossbar array 301 may receive input elements and perform a first MAC operation based on the first weight data. An operation result of the first crossbar array 301 may be provided as inputs to a multiplexer MUX 510, and the MUX 510 may select some of the plurality of inputs and transmit the selected inputs to an ADC 520. The ADC 520 may convert an analog current value output from the first crossbar array 301 into a digital signal. An adder 530 may generate an addition value corresponding to a neuron output by adding converted digital values. An activation function unit 540 may give nonlinearity to the neuron output, by applying, for example, an activation function such as a ReLU function and a sigmoid function. A register 550 may store an output value of a final neuron and then transmit the output value to the second crossbar array 302.

Second weight data may be stored in the second crossbar array 302. The second crossbar array 302 may receive the output value of the first crossbar array 301 as input elements and perform a second MAC operation based on the second weight data. An operation result of the second crossbar array 302 may be provided as inputs to a MUX 511, and the MUX 511 may select some of the plurality of inputs and transmit the selected inputs to an ADC 521. The ADC 521 may convert an analog current value output from the second crossbar array 302 into a digital signal. An adder 531 may generate an addition value corresponding to a neuron output by adding converted digital values. An activation function unit 541 may give nonlinearity to the neuron output, by applying, for example, an activation function such as a ReLU function and a sigmoid function. A register 551 may store an output value of a final neuron and then generate the output value as final output data.

The first crossbar array 301 and the second crossbar array 302 sequentially connected to each other in the in-memory computing circuit 350 illustrated in FIG. 8 may correspond to a hidden layer and an output layer of the MLP structure 4 illustrated in FIG. 7, respectively. For example, the in-memory computing circuit 350 may perform an operation corresponding to each layer of an MLP structure step by step through a sequentially connected crossbar array structure.

The electronic system 100 of the disclosure may perform branch prediction on the second PC, which is a relatively hard-to-predict PC, using the in-memory computing circuit 350 including a plurality of sequentially connected crossbar arrays, thereby learning the nonlinear relationship between the global history register value and the branch direction of the branch instruction corresponding to the second PC, and accordingly, improving the accuracy of branch prediction.

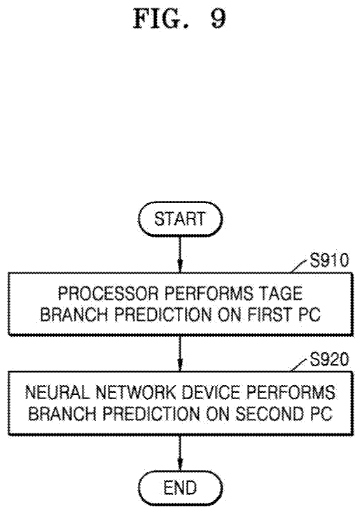

FIG. 9 is a flowchart for explaining an operating method of an electronic system performing branch prediction according to an embodiment.

Referring to FIG. 9, the operating method of the electronic system according to an embodiment includes operations processed in the electronic system 100 described with reference to FIGS. 1 to 8. Accordingly, the descriptions of the electronic system 100 described above with reference to FIGS. 1 to 8 may also be applied to the operating method of FIG. 9.

At operation S910, a processor (e.g., the processor 200 of FIGS. 5 and 6) may perform TAGE branch prediction on a first PC. In this regard, the first PC may mean a PC indicating that a miss prediction is low (e.g., a relatively easy-to-predict PC as discussed above, or a PC associated with a miss prediction that is relatively low).

The processor 200 may receive the first PC and a global history register value as input data. In this regard, the global history register value may mean a value stored in a global history register, and the global history register may include history information indicating branch results of recently executed branch instructions. For example, the global history register may include information sequentially storing results of branch directions (taken or not taken) of branch instructions up to the present time or a predetermined past time.

The processor 200 may generate an index to be used in a BHT by referring to the received first PC and global history register value. The processor 200 may predict a branch direction of a branch instruction corresponding to the first PC based on a BHT entry corresponding to the generated index. In this regard, the BHT may include history information about branch directions of all branch instructions, and the BHT entry may mean one slot (or cell) corresponding to a particular branch instruction in a table.

At operation S920, a neural network device (e.g., the neural network device 300 of FIGS. 5 and 6) may perform branch prediction on a second PC. In this case, the second PC may mean a PC indicated as having a high miss prediction (e.g., a relatively hard-to-predict PC as discussed above, or a PC associated with a miss prediction that is relatively high, or that is higher than the miss prediction associated with the first PC).

The neural network device 300 may include the in-memory computing circuit 350. The in-memory computing circuit 350 may perform at least one MAC operation on the input data. The input data may include the second PC and the global history register value.

However, the input data is not limited thereto, and the input data may further include a local history register value. In this regard, the local history register value may mean a value stored in a local history register, and the local history register may include history information indicating a branch result of a particular branch instruction. For example, the local history register may include information sequentially storing results of branch directions (taken or not taken) of branch instructions including a particular PC.

The neural network device 300 may generate the branch direction of the branch instruction corresponding to the second PC as output data based on an operation result of the in-memory computing circuit 350.

The neural network device 300 may include an MLP (e.g., the MLP structure 4 of FIG. 7). The MLP structure 4 may include an input layer, at least one hidden layer, and an output layer.

The neural network device 300 may learn a nonlinear relationship between the global history register value and the branch direction of the branch instruction corresponding to the second PC through the MLP structure 4. The neural network device 300 may receive the second PC and the global history register value as input data and generate a result of predicting the branch direction of the branch instruction corresponding to the second PC as output data.

Each layer included in the MLP structure 4 of the neural network device 300 may be implemented by a plurality of crossbar arrays each performing the MAC operation. The neural network apparatus 300 may perform a plurality of MAC operations using the plurality of crossbar arrays. For example, the plurality of crossbar arrays may be sequentially connected to perform the plurality of MAC operations corresponding to the respective layers of the MLP structure 4. The neural network device 300 may include a structure in which the plurality of crossbar arrays are hierarchically disposed, thereby performing a hierarchical operation based on the MLP structure 4.

The in-memory computing circuit 350 may include a first crossbar array (e.g., the first crossbar array 301 of FIG. 8) and a second crossbar array (e.g., the second crossbar array 302 of FIG. 8), and the first crossbar array 301 and the second crossbar array 302 may be sequentially connected to each other according to operation steps. For example, output data of the first crossbar array 301 may be input to the second crossbar array 302 as input data.

First weight data may be stored in the first crossbar array 301. The first crossbar array 301 may receive input elements and perform a first MAC operation based on the first weight data. An operation result of the first crossbar array 301 may be provided as inputs to the multiplexer MUX 510, and the MUX 510 may select some of the plurality of inputs and transmit the selected inputs to the ADC 520. The ADC 520 may convert an analog current value output from the first crossbar array 301 into a digital signal. The adder 530 may generate an addition value corresponding to a neuron output by adding converted digital values. The activation function unit 540 may give nonlinearity to the neuron output, by applying, for example, an activation function such as a ReLU function and a sigmoid function. The register 550 may store an output value of a final neuron and then transmit the output value to the second crossbar array 302.

Second weight data may be stored in the second crossbar array 302. The second crossbar array 302 may receive the output value of the first crossbar array 301 as input elements and perform a second MAC operation based on the second weight data. An operation result of the second crossbar array 302 may be provided as inputs to the MUX 511, and the MUX 511 may select some of the plurality of inputs and transmit the selected inputs to the ADC 521. The ADC 521 may convert an analog current value output from the second crossbar array 302 into a digital signal. The adder 531 may generate an addition value corresponding to a neuron output by adding converted digital values. The activation function unit 541 may give nonlinearity to the neuron output, by applying, for example, an activation function such as a ReLU function and a sigmoid function. The register 551 may store an output value of a final neuron and then generate the output value as final output data.

The operating method of the electronic system 100 of the disclosure may apply a TAGE prediction process associated with relatively low operation cost and resource consumption to a relatively easy-to-predict instruction, and apply a CNN-based prediction process associated with relatively high prediction accuracy to a relatively hard-to-predict instruction, thereby improving the overall accuracy of branch prediction and utilizing hardware resources more efficiently.

In addition, the operating method of the electronic system 100 of the disclosure may perform CNN-based branch prediction on a second PC, which is a relatively hard-to-predict PC, using a neural network device including an in-memory computing circuit, thereby improving energy efficiency by minimizing delay and power consumption due to a data movement while improving the overall accuracy of branch prediction.

In addition, the operating method of the electronic system 100 of the disclosure may perform branch prediction on the second PC, which is the relatively hard-to-predict PC, using an in-memory computing circuit including a plurality of sequentially connected crossbar arrays, thereby learning a nonlinear relationship between a global history register value and a branch direction of a branch instruction corresponding to the second PC, and accordingly, improving the accuracy of branch prediction.

Although some particular embodiments are described in detail above, the scope of the disclosure is not limited thereto, and various modifications and improvements made by those of ordinary skill in the art using the basic concept of the disclosure defined in the following claims also fall within the scope of the disclosure.

It should be understood that embodiments described herein should be considered in a descriptive sense only and not for purposes of limitation. Descriptions of features or aspects within each embodiment should be considered as available for other similar features or aspects in other embodiments. While one or more particular embodiments are described above with reference to the figures, it will be understood by those of ordinary skill in the art that various changes in form and details may be made therein without departing from the spirit and scope as defined by the following claims.

What is claimed is:

1. An electronic system for performing branch prediction, the electronic system comprising:
at least one processor configured to perform tagged geometry (TAGE) branch prediction on a first instruction corresponding to a first program counter (PC); and
a neural network device configured to perform neural network branch prediction on a second instruction corresponding to a second PC, wherein a miss prediction associated with the second PC is higher than a miss prediction associated with the first PC,
wherein the neural network device comprises an in-memory computing circuit, and
wherein the in-memory computing circuit is configured to:
receive first input data comprising the second PC and a global history register value, and
perform at least one multiply-accumulate (MAC) operation on the first input data.

2. The electronic system of claim 1, wherein the at least one processor is further configured to:
receive second input data comprising the first PC and the global history register value,
generate an index corresponding to a branch history table (BHT) based on the second input data, and
predict a branch direction of a branch instruction corresponding to the first PC based on a BHT entry corresponding to the generated index.

3. The electronic system of claim 1, wherein the neural network device is further configured to:
predict a branch direction of a branch instruction corresponding to the second PC based on an operation result of the at least one MAC operation performed by the in-memory computing circuit, and
generate output data comprising the predicted branch direction.

4. The electronic system of claim 1, wherein the first input data further comprises a local history register value corresponding to the second PC.

5. The electronic system of claim 1, wherein the at least one processor is further configured to:
classify a type of a PC as one of a first type corresponding to the first PC or a second type corresponding to the second PC based on a miss prediction rate of a branch instruction associated with the PC, and
based on the type of the PC being classified as the second type, transmit the PC to the neural network device.

6. The electronic system of claim 1, wherein the in-memory computing circuit is further configured to:
perform a plurality of MAC operations using a plurality of crossbar arrays.

7. The electronic system of claim 6, wherein the plurality of crossbar arrays are sequentially connected to each other according to operation steps.

8. The electronic system of claim 1, wherein the in-memory computing circuit comprises a first crossbar array configured to store first weight data, and a second crossbar array configured to store second weight data different from the first weight data.

9. The electronic system of claim 8, wherein the in-memory computing circuit is further configured to:
perform a first MAC operation on the first input data using the first crossbar array to obtain an operation result, and
perform a second MAC operation on the operation result using the second crossbar array.

10. An electronic device for performing branch prediction, the electronic device comprising:
at least one processor configured to perform tagged geometry (TAGE) branch prediction on a first instruction corresponding to a first program counter (PC); and
a neural network device configured to perform neural network branch prediction on a second instruction corresponding to a second PC, wherein a miss prediction associated with the second PC is higher than a miss prediction associated with the first PC,
wherein the neural network device comprises an in-memory computing circuit, and
wherein the in-memory computing circuit is configured to:
receive input data comprising the second PC and a global history register value, and
perform at least one multiply-accumulate (MAC) operation on the input data.

11. An operating method of an electronic system for performing branch prediction, the operating method comprising:
performing, by at least one processor, tagged geometry (TAGE) branch prediction on a first instruction corresponding to a first program counter (PC);
performing, by a neural network device, neural network branch prediction on a second instruction corresponding to a second PC, wherein a miss prediction associated with the second PC is higher than a miss prediction associated with the first PC;
receiving, by an in-memory computing circuit included in the neural network device, first input data comprising the second PC and a global history register value; and
performing, by the in-memory computing circuit, at least one multiply-accumulate (MAC) operation on the first input data.

12. The operating method of claim 11, wherein the performing of the TAGE branch prediction comprises:
receiving second input data comprising the first PC and the global history register value;
generating an index corresponding to a branch history table (BHT) based on the second input data; and
predicting a branch direction of a branch instruction corresponding to the first PC based on a BHT entry corresponding to the generated index.

13. The operating method of claim 11, wherein the performing of the neural network branch prediction comprises:
predicting a branch direction of a branch instruction corresponding to the second PC based on a MAC operation result of the at least one MAC operation performed by the in-memory computing circuit; and
generating output data comprising the predicted branch direction.

14. The operating method of claim 11, wherein the first input data further includes a local history register value corresponding to the second PC.

15. The operating method of claim 11, further comprising:
classifying, by the processor, a type of a PC as one of a first type corresponding to the first PC or a second type corresponding to the second PC based on a miss prediction rate of a branch instruction associated with the PC; and
based on the type of the PC being classified as the second type, transmitting, by the processor, the PC to the neural network device.

16. The operating method of claim 11, further comprising:
performing, using the in-memory computing circuit, a plurality of MAC operations using a plurality of crossbar arrays.

17. The operating method of claim 16, wherein the plurality of crossbar arrays are sequentially connected to each other according to operation steps.

18. The operating method of claim 16, wherein each crossbar array from among the plurality of crossbar arrays comprises a plurality of row lines, a plurality of column lines intersecting the plurality of row lines, and a plurality of nonvolatile memory cells disposed at intersections of the plurality of row lines and the plurality of column lines.

19. The operating method of claim 11, wherein the in-memory computing circuit comprises a first crossbar array configured to store first weight data and a second crossbar array configured to store second weight data different from the first weight data.

20. The operating method of claim 19, further comprising:
performing, using the in-memory computing circuit, a first MAC operation on the first input data using the first crossbar array to obtain an operation result, and
performing, using the in-memory computing circuit, a second MAC operation on the operation result using the second crossbar array.
